(19) United States
(12) Patent Application Publication
(10) Pub. No.: US 2026/0121807 A1
(43) Pub. Date: Apr. 30, 2026

(54) REDUCING PILOT SYMBOLS IN UPLINK OFDM TRANSMISSIONS, AND RELATED DEVICES, METHODS AND COMPUTER PROGRAMS

(71) Applicant: Nokia Solutions and Networks Oy, Espoo (FI)

(72) Inventors: Elias Aksel RANINEN, Espoo (FI); Dani Johannes KORPI, Espoo (FI)

(21) Appl. No.: 19/477,668

(22) PCT Filed: Mar. 11, 2024
(86) PCT No.: PCT/EP2024/056428

§ 371 Date: Oct. 22, 2025

(30) Foreign Application Priority Data
Apr. 28, 2023 (FI) 20235471

(51) Int. Cl. H04L 5/00; H04L 41/16; H04W 72/0453

(52) U.S. Cl. CPC H04L 5/0048; H04L 41/16; H04W 72/0453

(57) ABSTRACT

Devices, methods and computer programs for reducing pilot symbols in OFDM transmissions are disclosed. At least some of the example embodiments described herein may allow using an adaptive channel prediction scheme in an OFDM uplink transmission scenario to reduce an overhead caused by the pilot symbols.

### TECHNICAL FIELD

The disclosure relates generally to communications and, more particularly but not exclusively, to reducing pilot symbols in OFDM transmissions, as well as related devices, methods and computer programs.

### BACKGROUND

Advantages of orthogonal frequency division multiplexing (OFDM) used in fifth generation (5G) wireless networks include it being robust to frequency selective channels, and thus simplifying equalizer design as well as enabling high data rates.

In an OFDM uplink transmission, a user equipment (UE) may send data to a base station (BS) over a radio channel. In adynamic environment, radio channel conditions may usually be under constant change, and for the BS to reliably decode the information transmitted by the UE, channel state information (CSI) may be needed. To this end, the UE may send a sequence of pilot symbols, which may be known a priori at the BS receiver and may be used for estimating the CSI. Once the BS receiver has obtained an accurate estimate of the channel, the transmitted message may be successfully decoded.

In 5G wireless networks, information may be sent in transmission time intervals (TTIs), which may usually comprise, e.g., 14 OFDM symbols. Conventionally, each TTI may incorporate a set of pilot symbols such as demodulation reference signals (DMRS) in 5G wireless networks. The pilot symbols may occupy several resource elements of a resource grid, and hence, reduce the overall efficiency of a communication link. The less pilot symbols need to be transmitted, the higher the data rates that can be obtained, as the information can be more efficiently transmitted.

Accordingly, at least in some situations, there may be a need to reduce the amount of pilot symbols in OFDM transmissions.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of a network node device comprises at least one processor, and at least one memory storing instructions that, when executed by the at least one processor, cause the network node device at least to perform determining to reduce amount of pilot symbols in transmission time intervals, TTIs, of uplink orthogonal frequency division multiplexing, OFDM, transmissions from a client device over a radio channel for at least one reduction period of one or more TTIs, in response to a transmission quality criterion being fulfilled. The instructions, when executed by the at least one processor, further cause the network node device at least to perform instructing the client device to transmit reduced sets of the pilot symbols during the at least one reduction period. The instructions, when executed by the at least one processor, further cause the network node device at least to perform channel prediction for the radio channel based at least on a non-reduced set of the pilot symbols during the at least one reduction period.

In an example embodiment, alternatively or in addition to the above-described example embodiments, the performed channel prediction is further based on at least one reduced set of the pilot symbols.

In an example embodiment, alternatively or in addition to the above-described example embodiments, the at least one reduction period comprises TTIs between every nth TTI and the channel prediction is performed for TTIs having a reduced set of the pilot symbols.

In an example embodiment, alternatively or in addition to the above-described example embodiments, the reduced sets of the pilot symbols comprise pilot symbols reduced in frequency domain.

In an example embodiment, alternatively or in addition to the above-described example embodiments, the reduced sets of the pilot symbols comprise no pilot symbols.

In an example embodiment, alternatively or in addition to the above-described example embodiments, the transmission quality criterion comprises a block error rate, BLERₙ difference between using a prediction of the radio channel and using a current estimate of the radio channel not exceeding a transmission quality threshold in TTIs not included in the at least one reduction period.

In an example embodiment, alternatively or in addition to the above-described example embodiments, the BLER difference between using the prediction of the radio channel and using the current estimate of the radio channel not exceeding the transmission quality threshold in the TTIs not included in the at least one reduction period comprises:

$$B L E {R}_{{n}^{′}} - B L E {R}_{n} \leq {A}_{n} ( 1 - \frac{{B}_{n}}{{B}_{{n}^{′}}} )$$

in which Aₙ=(1-BLERₙ)∈[0,1], BLERₙ represents an average block error rate when transmitting non-reduced pilot symbols every nth TTI,

$${B}_{n} = ( 1 - \frac{{N}_{p}}{n {N}_{FFT} {N}_{OFDM}} ) ,$$

N_{FFT} represents a number of subcarriers, N_{OFDM} represents a number of OFDM symbols in a TTI, and Nₚ represents a number of pilot symbols in every nth TTI, for switching from transmitting pilot symbols at every nth TTI to transmitting pilot symbols at every n'th TTI.

In an example embodiment, alternatively or in addition to the above-described example embodiments, when every mth pilot symbol is transmitted between every nth TTI, the BLER difference between using the prediction of the radio channel and using the current estimate of the radio channel not exceeding the transmission quality threshold in the TTIs not included in the at least one reduction period further comprises:

$$B L E {R}_{{n}^{′} , {m}^{′}} - B L E {R}_{n , m} \leq {A}_{n , m} ( 1 - \frac{{B}_{n , m}}{{B}_{{n}^{′} , {m}^{′}}} )$$

as a criterion for switching from transmitting Nₚ pilot symbols at every nth TTI and Nₚ/m pilot symbols between every nth TTI to transmitting Nₚ pilot symbols at every n'th TTI and Nₚ/m′ pilot symbols between every n'th TTI, in which A_{n,m}=(1−BLER_{n,m}) represents an average block success rate using parameters n and m, and

$${B}_{n , m} = ( 1 - \frac{1}{n} ( 1 + \frac{n - 1}{m} ) \frac{{N}_{p}}{{N}_{F F T} {N}_{O F D M}} )$$

represents an average proportion of data carrying resource elements using parameters n and m.

In an example embodiment, alternatively or in addition to the above-described example embodiments, the performing of the channel prediction comprises, for a n-length sequence of TTIs defined by its first three terms, TTI 1: predicting the radio channel using non-reduced pilot symbols of TTI 1, for TTI 2: predicting the radio channel using reduced pilot symbols of TTI 2 and the non-reduced pilot symbols of TTI 1, and for TTI 3: predicting the radio channel using reduced pilot symbols of TTI 3 and at least the non-reduced pilot symbols of TTI 1.

In an example embodiment, alternatively or in addition to the above-described example embodiments, the performing of the channel prediction comprises, for a n-length sequence of TTIs defined by its first three terms, TTI 1: predicting the radio channel using non-reduced pilot symbols of TTI 1, for TTI 2: using reduced pilot symbols of TTI 2 to update the channel prediction obtained from using the non-reduced pilot symbols of TTI 1, and for TTI 3: using at least reduced pilot symbols of TTI 3 to update the channel prediction obtained from using the non-reduced pilot symbols of TTI 1.

In an example embodiment, alternatively or in addition to the above-described example embodiments, the performing of the channel prediction comprises applying a set of raw channel estimates from a previous TTI not included in the at least one reduction period as input to a machine learning, ML, model configured to predict the channel.

In an example embodiment, alternatively or in addition to the above-described example embodiments, the ML model comprises an ML model able to process a varying number of inputs.

An example embodiment of a method comprises determining, by a network node device, to reduce the amount of pilot symbols in transmission time intervals, TTIs, of uplink orthogonal frequency division multiplexing, OFDM, transmissions from a client device over a radio channel for at least one reduction period of one or more TTIs, in response to a transmission quality criterion being fulfilled. The method further comprises instructing, by the network node device, the client device to transmit reduced sets of the pilot symbols during the at least one reduction period. The method further comprises performing, by the network node device, channel prediction for the radio channel based at least on a non-reduced set of the pilot symbols during the at least one reduction period.

In an example embodiment, alternatively or in addition to the above-described example embodiments, the performed channel prediction is further based on at least one reduced set of the pilot symbols.

In an example embodiment, alternatively or in addition to the above-described example embodiments, the at least one reduction period comprises TTIs between every nth TTI and the channel prediction is performed for TTIs having a reduced set of the pilot symbols.

In an example embodiment, alternatively or in addition to the above-described example embodiments, the reduced sets of the pilot symbols comprise pilot symbols reduced in frequency domain.

In an example embodiment, alternatively or in addition to the above-described example embodiments, the reduced sets of the pilot symbols comprise no pilot symbols.

In an example embodiment, alternatively or in addition to the above-described example embodiments, the transmission quality criterion comprises a block error rate, BLERₙ difference between using a prediction of the radio channel and using a current estimate of the radio channel not exceeding a transmission quality threshold in TTIs not included in the at least one reduction period.

In an example embodiment, alternatively or in addition to the above-described example embodiments, the BLER difference between using the prediction of the radio channel and using the current estimate of the radio channel not exceeding the transmission quality threshold in the TTIs not included in the at least one reduction period comprises:

$$B L E {R}_{{n}^{′}} - B L E {R}_{n} \leq {A}_{n} ( 1 - \frac{{B}_{n}}{{B}_{{n}^{′}}} )$$

in which Aₙ=(1−BLERₙ)∈[0,1], BLERₙ represents an average block error rate when transmitting non-reduced pilot symbols every nth TTI,

$${B}_{n} = ( 1 - \frac{{N}_{p}}{n {N}_{F F T} {N}_{O F D M}} ) ,$$

N_{FFT} represents a number of subcarriers, N_{OFDM} represents a number of OFDM symbols in a TTI, and Nₚ represents a number of pilot symbols in every nth TTI, for switching from transmitting pilot symbols at every nth TTI to transmitting pilot symbols at every n'th TTI. In an example embodiment, alternatively or in addition to the above-described example embodiments, when every mth pilot symbol is transmitted between every nth TTI, the BLER difference between using the prediction of the radio channel and using the current estimate of the radio channel not exceeding the transmission quality threshold in the TTIs not included in the at least one reduction period further comprises:

$$B L E {R}_{{n}^{′} , {m}^{′}} - B L E {R}_{n , m} \leq {A}_{n , m} ( 1 - \frac{{B}_{n , m}}{{B}_{{n}^{′} , {m}^{′}}} )$$

as a criterion for switching from transmitting Nₚ pilot symbols at every nth TTI and Nₚ/m pilot symbols between every nth TTI to transmitting Nₚ pilot symbols at every n'th TTI and Nₚ/m′ pilot symbols between every n'th TTI, in which A_{n,m}=(1−BLER_{n,m}) represents an average block success rate using parameters n and m, and

$${B}_{n , m} = ( 1 - \frac{1}{n} ( 1 + \frac{n - 1}{m} ) \frac{{N}_{p}}{{N}_{F F T} {N}_{O F D M}} )$$

represents an average proportion of data carrying resource elements using parameters n and m.

In an example embodiment, alternatively or in addition to the above-described example embodiments, the performing of the channel prediction comprises, for a n-length sequence of TTIs defined by its first three terms, TTI 1: predicting the radio channel using non-reduced pilot symbols of the TTI 1, for TTI 2: predicting the radio channel using reduced pilot symbols of TTI 2 and the non-reduced pilot symbols of TTI 1, and for TTI 3: predicting the radio channel using reduced pilot symbols of TTI 3 and at least the non-reduced pilot symbols of TTI 1.

In an example embodiment, alternatively or in addition to the above-described example embodiments, the performing of the channel prediction comprises, for a n-length sequence of TTIs defined by its first three terms, TTI 1: predicting the radio channel using non-reduced pilot symbols of the TTI 1, for TTI 2: using reduced pilot symbols of TTI 2 to update the channel prediction obtained from using the non-reduced pilot symbols of TTI 1, and for TTI 3: using at least reduced pilot symbols of TTI 3 to update the channel prediction obtained from using the non-reduced pilot symbols of TTI 1.

In an example embodiment, alternatively or in addition to the above-described example embodiments, the performing of the channel prediction comprises applying a set of raw channel estimates from a previous TTI not included in the at least one reduction period as input to a machine learning, ML, model configured to predict the channel.

In an example embodiment, alternatively or in addition to the above-described example embodiments, the ML model comprises an ML model able to process a varying number of inputs.

An example embodiment of a computer program comprises instructions for causing a network node device to perform at least the following: determining to reduce the amount of pilot symbols in transmission time intervals, TTIs, of uplink orthogonal frequency division multiplexing, OFDM, transmissions from a client device over a radio channel for at least one reduction period of one or more TTIs, in response to a transmission quality criterion being fulfilled; instructing the client device to transmit reduced sets of the pilot symbols during the at least one reduction period; and performing channel prediction for the radio channel based at least on a non-reduced set of the pilot symbols during the at least one reduction period.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2 shows an example embodiment of the subject matter described herein illustrating a network node device;

FIG. 3 shows an example embodiment of the subject matter described herein illustrating joint estimation and prediction using reduced pilot symbols between every nth TTI;

FIG. 4 shows an example embodiment of the subject matter described herein illustrating network node device decision logic for tracking channel prediction accuracy with full pilot symbol muting and taking corrective action if necessary;

FIG. 5 shows an example embodiment of the subject matter described herein illustrating network node device decision logic for tracking channel prediction accuracy when using reduced pilot symbols between every nth TTI; and

FIG. 6 shows an example embodiment of the subject matter described herein illustrating a method.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

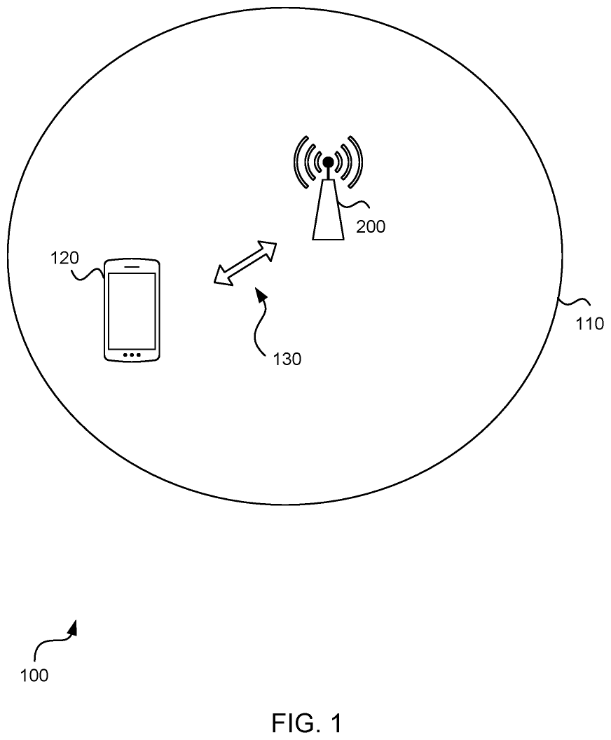

FIG. 1 illustrates an example system 100, where various embodiments of the present disclosure may be implemented. The system 100 may comprise a fifth generation (5G) new radio (NR) network or a network beyond 5G wireless networks, 110. An example representation of the system 100 is shown depicting a client device 120, a radio channel 130, and a network node device 200. At least in some embodiments, the network 110 may comprise one or more massive machine-to-machine (M2M) network(s), massive machine type communications (mMTC) network(s), internet of things (IoT) network(s), industrial internet-of-things (IIoT) network(s), enhanced mobile broadband (eMBB) network(s), ultra-reliable low-latency communication (URLLC) network(s), and/or the like. In other words, the network 110 may be configured to serve diverse service types and/or use cases, and it may logically be seen as comprising one or more networks.

The client device 120 may include, e.g., a mobile phone, a smartphone, a tablet computer, a smart watch, or any handheld, portable and/or wearable device. The client device 120 may also be referred to as a user equipment (UE). The network node device 200 may comprise a base station. The base station may include, e.g., any device suitable for providing an air interface for client devices to connect to a wireless network via wireless transmissions.

In an orthogonal frequency division multiplexing (OFDM) transmission, data symbols, represented, e.g., by complex numbers, may be mapped to resource elements in a resource grid, which is a time-frequency representation of a transmitted signal. A time axis of the resource grid may be in units of OFDM symbols, and a corresponding frequency axis may be in units of subcarriers. For example, if the duration of an OFDM symbol is T seconds, then the subcarrier spacing is 1/T Hertz. Before a transmission, an inverse discrete Fourier transform (IDFT) may be applied to an OFDM symbol, and a cyclic prefix (CP) may be added. The CP may simplify receiver processing by mitigating inter-symbol interference (ISI) as well as enable the channel to be treated as a circular convolution with the transmitted signal. As the transmitted signal propagates through a wireless channel, it may get distorted due to various channel effects, such as multipath, scattering, doppler, and/or large- and small-scale fading. For the receiver to decode the transmitted signal, the channel distortions may need to be estimated, and their effects may need to be reversed. Channel estimation is therefore a processing step at the receiver, whose successfulness may determine the performance of the whole communication system.

As discussed above, in a dynamic environment, radio channel conditions may be under constant change, and for a network node device or base station (BS) to reliably decode the information transmitted by a client device, channel state information (CSI) may be needed. To this end, the client device may send a sequence of pilot symbols, which may be known a priori at the BS receiver and may be used for estimating the CSI. Once the BS receiver has obtained an accurate estimate of the channel, the transmitted message may be successfully decoded. In 5G wireless networks, information may be sent in transmission time intervals (TTIs) or slots, which may usually comprise, e.g., 14

OFDM symbols. Herein, the terms TTI and slot are used interchangeably. Conventionally, each TTI may incorporate a set of pilot symbols such as demodulation reference signals (DMRS) in 5G wireless networks. The pilot symbols may occupy several resource elements of the resource grid, and hence, reduce the overall efficiency of a communication link. The less pilot symbols need to be transmitted, the higher the data rates that can be obtained, as the information can be more efficiently transmitted.

In channel prediction, an objective is to predict a future radio channel state based on previous radio channel estimates. In highly time-varying channel conditions, the current CSI at the transceiver may have already become outdated when it is needed in a signal processing block, thus leading to inferior performance. Channel prediction may be used, e.g., in frequencydivision duplex (FDD) systems, where the radio channel may be different for uplink and downlink, i.e., it may not be reciprocal. Therefore, in FDD, the CSI may first be estimated at the receiver and then sent back to the transmitter, thus creating a feedback delay that can result in channel aging. Also, in time-division duplex (TDD), channel prediction may be needed, e.g., in a case in which pilot symbols are transmitted only for a first couple of OFDM symbols in a slot and they may become outdated for the last remaining OFDM symbols in the slot.

For example, one TTI or slot of received data by one of the antennas at the BS may amount to N_{OFDM} OFDM symbols and N_{FFT} subcarriers. In OFDM systems, before further processing, the time-domain signals (corresponding to OFDM symbols) may first be transformed to the frequency domain by removing the CP and applying a discrete Fourier transform (DFT). Then, the received data may be represented in a resource grid, whose resource elements may be given, e.g., by:

$${y}_{i j} = {h}_{ij} {x}_{i j} + {n}_{i j} ∈ ℂ , i = 1 , … , {N}_{OFDM} , j = 1 , … , {N}_{FFT} , \qquad ( 1 )$$

in which yᵢⱼ represents the received data, xᵢⱼ represents the sent data symbol, nᵢⱼ represents (circularly symmetric) zero mean complex Gaussian noise, and the subscripts i and j refer to OFDM symbol i and subcarrier j, respectively. The goal at the receiver is to estimate the data symbols xᵢⱼ, for all i,j. To this end, the receiver may first need to know the channel coefficients hᵢⱼ. In a conventional OFDM transmission, a fraction of the resource elements in the resource grid may be allocated for pilot symbols, whose purpose is to facilitate channel estimation at the receiver. The pilot symbols may be distributed in different ways in the resource grid.

As an example, from a TTI received from one of the antennas at the BS, the resource elements corresponding to the pilot symbols may be collected into a vector y defined by y=h·p+n∈ [symbol] ^{N}^{ₚ}, in which ·denotes element-wise product, h denotes the (unknown) channel coefficients, p denotes the (known) pilot symbols, n denotes zero mean (circularly symmetric) complex Gaussian noise, and Nₚ denotes the number of pilot symbols. Raw channel estimates (in the least-square sense) may be obtained, e.g., by:

$${\hat{h}}_{r a w} = y p , \qquad ( 2 )$$

in which Ø denotes element-wise division.

In the following, various example embodiments will be discussed. At least some of the example embodiments described herein may allow reducing pilot symbols in OFDM transmissions.

More specifically, at least some of the example embodiments described herein may allow using an adaptive channel prediction scheme in an OFDM uplink transmission scenario to reduce an overhead caused by the pilot symbols. In other words, at least some of the example embodiments described herein may allow using channel prediction instead of pilot-based channel estimation in certain situations to reduce the overhead.

Furthermore, at least some of the example embodiments described herein may allow achieving reduction in reference signal (RS) overhead via switching off pilot symbol transmission when possible.

Furthermore, at least some of the example embodiments described herein may allow implementing use of channel prediction and RS overhead reduction in a versatile and adaptive manner.

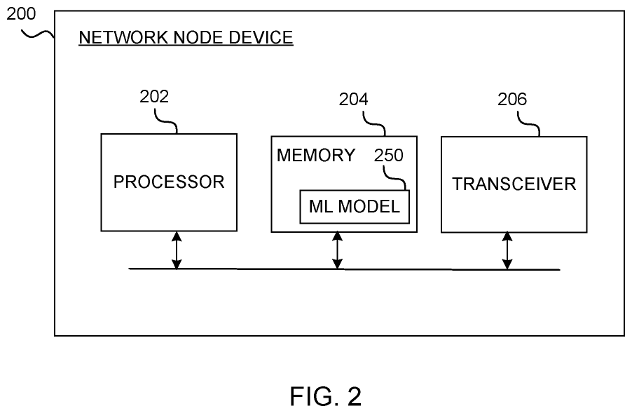

FIG. 2 is a block diagram of the network node device 200, in accordance with an example embodiment.

The network node device 200 comprises one or more processors 202 and one or more memories 204 that comprise computer program code. The network node device 200 may also include other elements, such as a transceiver 206 configured to enable the network node device 200 to transmit and/or receive information to/from other devices, as well as other elements not shown in FIG. 2. In one example, the network node device 200 may use the transceiver 206 to transmit or receive signaling information and data in accordance with at least one cellular communication protocol. The transceiver 206 may be configured to provide at least one wireless radio connection, such as for example a 3GPP mobile broadband connection (e.g., 5G or beyond). The transceiver 206 may comprise, or be configured to be coupled to, at least one antenna to transmit and/or receive radio frequency signals.

Although the network node device 200 is depicted to include only one processor 202, the network node device 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments, such as a machine learning (ML) model 250 described in more detail below.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) accelerator, a tensor processing unit (TPU), a neural processing unit (NPU), or the like. In an embodiment, the processor 202 may be configured to execute hardcoded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The network node device 200 may comprise a base station. The base station may include, e.g., a 5G base station (gNB) or any such device providing an air interface for client devices to connect to a wireless network via wireless transmissions.

When executed by the at least one processor 202, instructions stored in the at least one memory 204 cause the network node device 200 at least to perform determining to reduce the amount of pilot symbols in transmission time intervals (TTIs) of uplink orthogonal frequency division multiplexing (OFDM) transmissions from the client device 120 over the radio channel 130 for at least one reduction period of one or more TTIs, in response to a transmission quality criterion being fulfilled.

In other words, and as described in more detail below, the network node device 200 may be configured to identify a situation where it does not need all of the pilot symbols for every TTI.

The instructions, when executed by the at least one processor 202, further cause the network node device 200 at least to perform instructing the client device 120 to transmit reduced sets of the pilot symbols during the at least one reduction period. For example, the reduced sets of the pilot symbols may comprise pilot symbols reduced in frequency domain.

The instructions, when executed by the at least one processor 202, further cause the network node device 200 at least to perform channel prediction for the radio channel 130 based at least on a non-reduced set of the pilot symbols during the at least one reduction period. At least in some embodiments, the performed channel prediction may further be based on at least one reduced set of the pilot symbols.

At least in some embodiments, the reduced sets of the pilot symbols may comprise no pilot symbols. That is, the pilot symbols may be completely removed from the respective TTIs.

At least in some embodiments, the at least one reduction period may comprise TTIs between every nth TTI and the channel prediction may be performed for TTIs having a reduced set of the pilot symbols.

In other words, the network node device 200 may be configured to signal the client device 120 to send either no pilot symbols or reduced pilot symbols, e.g., between every nth TTI, and the network node device 200 may be configured to predict the radio channel 130 between every nth TTI using the pilot symbols of the previous TTI containing non-reduced pilots and optionally the (possibly) transmitted reduced sets of pilots between every nth TTI.

As mentioned above, the reduction of the pilot symbols may be performed in the frequency domain. For example, when every nth TTI contains two OFDM symbols of pilots at each subcarrier, then at the subsequent n−1 TTIs, the corresponding OFDM symbols may have pilots only at every mth subcarrier. In certain situations, the pilot transmission may be completely muted between every nth TTI.

The herein discussed approach for channel prediction may be used to reduce the RS overhead due to pilot transmissions. In the following, a case when pilots are fully muted between every nth TTI is described first, and then it is generalized toa case when reduced pilots are sent between every nth TTI. At least in some embodiments, the transmission quality criterion may comprise a block error rate, BLERₙ difference between using a prediction of the radio channel 130 and using a current estimate of the radio channel 130 not exceeding a transmission quality threshold in TTIs not included in the at least one reduction period.

For example, the BLER difference between using the prediction of the radio channel 130 and using the current estimate of the radio channel 130 not exceeding the transmission quality threshold in the TTIs not included in the at least one reduction period may comprise:

$$B L E {R}_{{n}^{′}} - B L E {R}_{n} \leq {A}_{n} ( 1 - \frac{{B}_{n}}{{B}_{{n}^{′}}} ) \qquad ( 3 )$$

in which Aₙ=(1−BLERₙ)∈[0,1], BLERₙ represents an average block error rate when transmitting non-reduced pilot symbols of every nth TTI,

$${B}_{n} = ( 1 - \frac{{N}_{p}}{n {N}_{F F T} {N}_{O F D M}} ) ,$$

N_{FFT} represents a number of subcarriers, N_{OFDM} represents a number of OFDM symbols in a TTI, and Nₚ represents a number of pilot symbols in every nth TTI, for switching from transmitting pilot symbols at every nth TTI to transmitting pilot symbols at every n'th TTI.

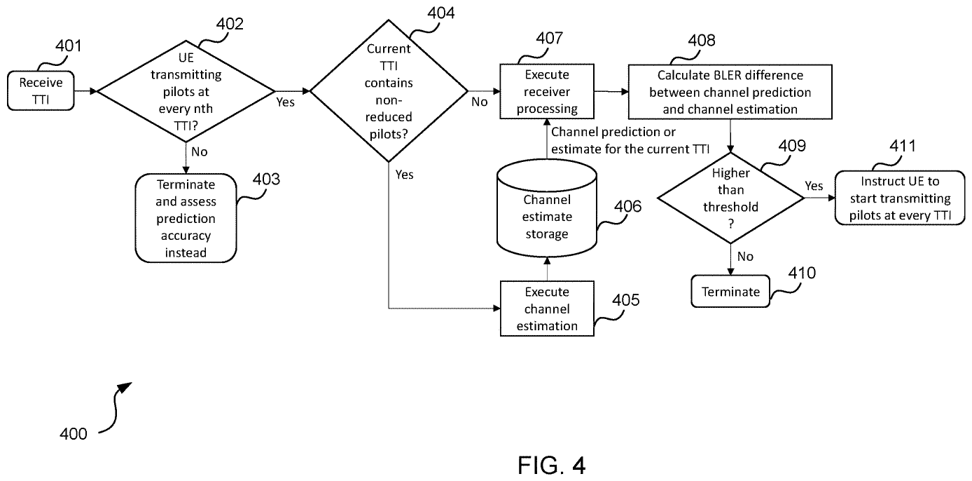

In other words, when using the channel prediction method for reducing the pilot interval, at least in some situations receiver performance may be tracked. In the case that pilot symbols are fully muted between every nth TTI, an example of the logic for tracking the receiver performance is depicted in diagram 400 of FIG. 4. More specifically, operations 401-411 illustrate an example of the network node device decision logic for tracking channel prediction accuracy with full pilot symbol muting and taking corrective action if necessary. For example, the network node device 200 may constantly compare the BLER of the pilot-carrying TTIs to those demodulated using a predicted channel, operations 408-409. If the BLER difference exceeds a predefined threshold, this may indicate that the channel conditions are no more favorable for using the prediction, and the network node device 200 may instruct the client device 120 to start transmitting pilot symbols again at every TTI, operation 411. The transmission quality threshold may be calculated based on expected throughput and considering a reduced pilot overhead which allows for a somewhat higher BLER.

An example of switching to transmitting pilots only at every nth TTI is described next. Let Aₙ=(1−BLERₙ)∈[0,1], where BLER denotes the average block error rate when transmitting pilots only every nth TTI. That is, with n=1, pilots are transmitted at every TTI, and when n=2, pilots are transmitted at every second TTI. Let

$${B}_{n} = ( 1 - \frac{{N}_{p}}{n {N}_{F F T} {N}_{O F D M}} ) ,$$

where N_{FFT} is the number of subcarriers, N_{OFDM} is the number of OFDM symbols in a TTI, and Nₚ is the number of pilots in every nth TTI. Hence, Bₙ is the average proportion of data carrying resource elements of the resource grid, when transmitting pilots at every nth TTI. The goal is then to maximize the product AₙBₙ, for n≥1. From currently transmitting at every nth TTI, switching to transmitting pilots at every n'th TTI may be done if Aₙ′Bₙ′>AₙBₙ, which is equivalent to the criteria of equation (3) above. For example, if pilot symbols are currently transmitted at every TTI, a switch to transmitting pilots at every second TTI may be performed if equation (3) is satisfied for (n=1, n′=2). Reducing the prediction length may be done incrementally in steps, or by directly reverting back to transmitting pilots at every TTI (as shown in diagram 400 of FIG. 4).

For another example, when every mth pilot symbol is transmitted between every nth TTI, the BLER difference between using the prediction of the radio channel 130 and using the current estimate of the radio channel 130 not exceeding the transmission quality threshold in the TTIs not included in the at least one reduction period may further comprise:

$$B L E {R}_{{n}^{′} , {m}^{′}} - B L E {R}_{n , m} \leq {A}_{n , m} ( 1 - \frac{{B}_{n , m}}{{B}_{{n}^{′} , {m}^{′}}} ) \qquad ( 4 )$$

as a criterion for switching from transmitting Nₚ pilot symbols at every nth TTI and Nₚ/m pilot symbols between every nth TTI to transmitting Nₚ pilot symbols at every n'th TTI and Nₚ/m′ pilot symbols between every n'th TTI, in which A_{n,m}=(1−BLER_{n,m}) represents an average block success rate using parameters n and m, an

$${B}_{n , m} = ( 1 - \frac{1}{n} ( 1 + \frac{n - 1}{m} ) \frac{{N}_{p}}{{N}_{F F T} {N}_{O F D M}} )$$

represents an average proportion of data carrying resource elements using parameters n and m.

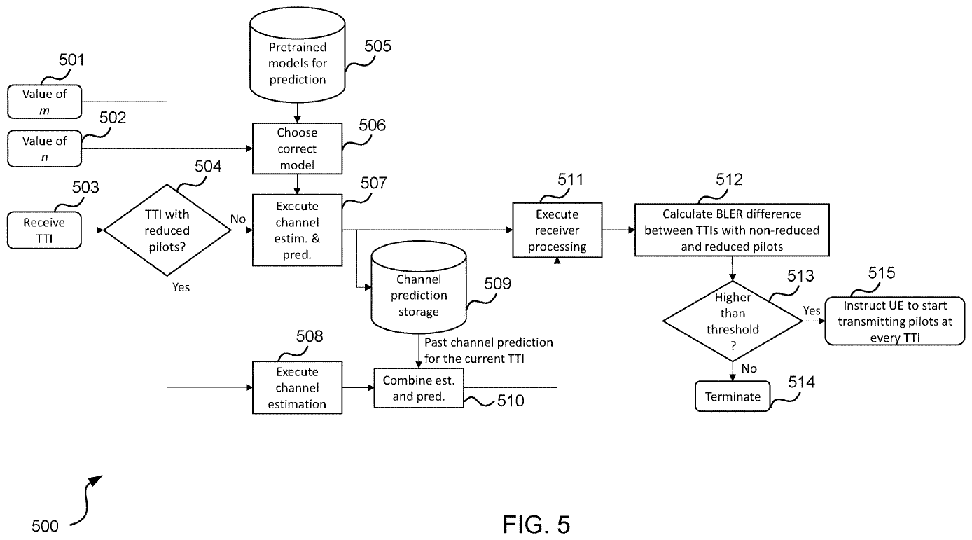

In other words, in the case where instead of completely muting the pilot transmission between every nth TTI, reduced pilots are transmitted between every nth TTI, the decision logic may be as depicted in operations 501-515 of diagram 500 of FIG. 5, for example. When reduced pilots are transmitted, only every mth pilot symbol may be transmitted between every nth TTI, operation 504. That is, for each pilot symbol(s) carrying OFDM symbol, only every mth subcarrier contains a pilot symbol. In this case, the average block success rate is A_{n,m}=(1−BLER_{n,m}) and the average proportion of data carrying resource elements is

$${B}_{n , m} = ( 1 - \frac{1}{n} ( 1 + \frac{n - 1}{m} ) \frac{{N}_{p}}{{N}_{F F T} {N}_{O F D M}} ) .$$

Bn is the limiting case of B_{n,m}, when n−1/m→0, whereas B_{n,1} for any n and B_{1,m} for any m correspond to regular pilot transmission. The goal is to maximize A_{n,m}B_{n,m} over n and m. Thus, if currently transmitting Nₚ pilots at every nth TTI and Nₚ/m pilots between every nth TTI, switching to transmit Nₚ pilots at every n'th TTI and Nₚ/m′ pilots between every n'th TTI may be done if the above equation (4) is satisfied. A simple approach may include, e.g., always comparing the performance of the parameter pair n′>1 and m′>1 against n=1 or m=1, i.e., the case with no pilot reduction.

At least in some embodiments, the performing of the channel prediction may comprise, for a n-length sequence of TTIs defined by its first three terms, TTI 1: predicting the radio channel 130 using non-reduced pilot symbols of TTI 1, for TTI 2: predicting the radio channel 130 using reduced pilot symbols of TTI 2 and the non-reduced pilot symbols of TTI 1, and for TTI 3: predicting the radio channel 130 using reduced pilot symbols of TTI 3 and at least the non-reduced pilot symbols of TTI 1.

Alternatively/additionally, the performing of the channel prediction may comprise, for a n-length sequence of TTIs defined by its first three terms, TTI 1: predicting the radio channel 130 using non-reduced pilot symbols of TTI 1, for TTI 2: using reduced pilot symbols of TTI 2 to update the channel prediction obtained from using the non-reduced pilot symbols of TTI 1, and for TTI 3: using at least reduced pilot symbols of TTI 3 to update the channel prediction obtained from using the non-reduced pilot symbols of TTI 1.

In other words, as discussed above, instead of muting the pilot symbols altogether, in certain situations it may be better to transmit reduced pilots between every nth TTI. When reduced pilots are used, every mth pilot in the frequency domain may be selected for an actual transmission. For example, the value m=2 would correspond to transmitting only every other pilot symbol, whereas m=1 would correspond to regular pilot transmission. The selection of an optimal reduction level m may be carried out at, e.g., the network node device 200.

When using machine learning (ML) model(s) at the network node device 200, they may be trained to predict or estimate the channel state accurately with different combinations of parameters n and m as well as in highly varying channel conditions. Furthermore, the ML models may also be able to adapt toa different number of received pilot symbols determined by m.

Examples of ML architectures that may handle varying number of inputs include, for instance, fully convolutional neural networks (FCNs). In scenarios where using variable size inputs is not possible, the reduced pilot symbols may be combined or used to replace pilot symbols of the previous non-reduced TTI in order to keep the number of inputs unchanged. Alternatively, zero-padding may be used.

When reduced pilots are transmitted between every nth TTI, there may be several alternative approaches for predicting the channel. Assuming a sequence of TTIs where n≥3 and m≥2,different approaches of how to estimate the radio channel 130 are described next by the first three terms of the sequence:

### Approach 1:

TTI 1: estimate channel using the non-reduced pilots of TTI 1,
TTI 2: estimate the channel using the reduced pilots of
TTI 2 as well as the non-reduced pilots of TTI 1, and
TTI 3: estimate the channel using the reduced pilots of TTI 3 as well as the non-reduced pilots of TTI 1 (and optionally also the reduced pilots of TTI 2).

Here, the estimation may be done, e.g., by using an algorithm or an ML model.

### Approach 2:

TTI 1: estimate the channel using the non-reduced pilots of TTI 1,
TTI 2: use the reduced pilots of TTI 2 to update the channel prediction computed using the pilots of TTI 1, and
TTI 3: use the reduced pilots of TTI 3 (and optionally also the reduced pilots of TTI 2) to update the channel prediction computed using the non-reduced pilots of TTI 1.

In Approach 2, updating the channel prediction may be done in different ways. Considering channel prediction of TTI 3, there are, e.g., the following options:
Approach 2A: use an algorithm or a ML model with inputs: channel prediction of TTI 3 (computed from pilots of TTI 1) and the reduced pilots of TTI 3 (optionally also reduced pilots of TTI 2); and
Approach 2B: separately estimate the radio channel 130 using only the reduced pilots of TTI 3 and then combine the estimate with the channel prediction of TTI 3 computed from pilots of TTI 1. In the simplest case, the combination may comprise a simple weighted average, and in a more elaborate case, a trained neural network, for example.

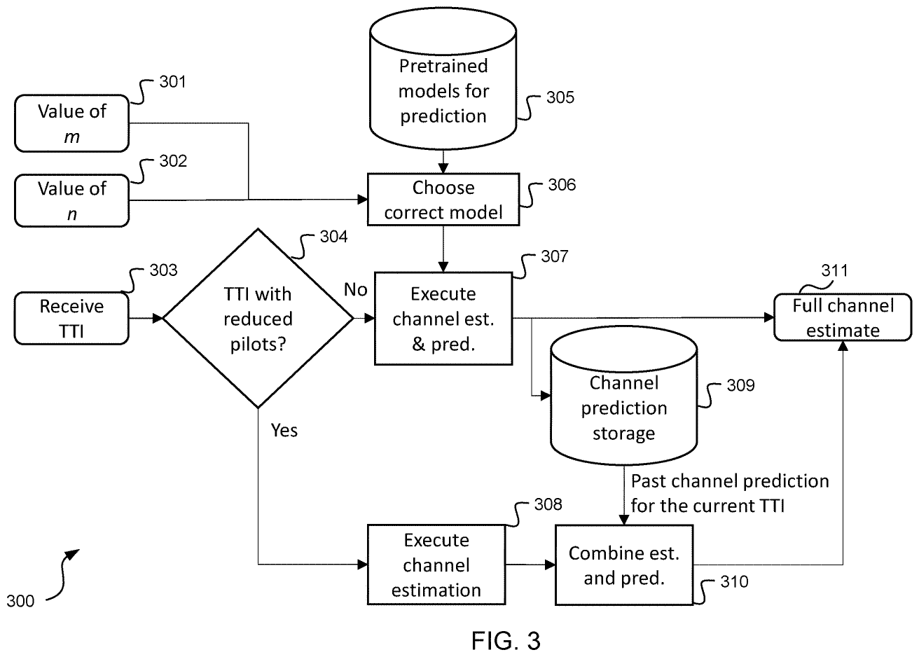

Diagram 300 of FIG. 3 illustrates the joint estimation and prediction of the Approach 2B using reduced pilot symbols between every nth TTI. At operation 304, it is identified if the currently received slot 303 has reduced pilots. If this is not the case, the radio channel 130 may be estimated at operations 301-302, 305-310 as per the usual procedure (which may or may not involve the ML model 250), and this estimate 311 may then be used for the forthcoming receiver processing. In addition to channel estimation of the current non-reduced TTI, channel prediction for subsequent TTIs may be executed, and the resulting prediction is stored in memory at operation 309. The prediction may be carried out with a model corresponding to currently-in-use parameter values of n and m. If reduced pilots are used (i.e., m>1), an initial estimate of the radio channel 130 may be computed based on the reduced pilots, after which it may be combined with the predicted radio channel. Hence, data may be used from several TTIs to obtain an as accurate as possible channel estimate for the forthcoming receiver processing.

At least in some embodiments, the performing of the channel prediction may comprise applying a set of raw channel estimates from a previous TTI not included in the at least one reduction period as input to the ML model 250 that is configured to predict the channel. At least in some embodiments, the ML model 250 may comprise an ML model able to process a varying number of inputs. For example, the raw channel estimates may include the ones of the previous TTI having non-reduced sets of pilots.

In other words, the channel prediction may be performed using a neural network (NN), e.g., when pilot symbols are completely muted between every nth TTI. For example, the raw channel estimate ĥ_{raw} of equation (2) above may first be mapped to a real-valued vector via a complex-to-real mapping defined for a∈ [symbol] ⁿ by [symbol] R=(Re(a^{T}), Im(a^{T}))^{T}. Then [symbol] may be given as input to the NN, which may have in its output layer as many units as the input vector (i.e., 2Nₚ) and a linear activation function. It is to be noted that a complex-valued NN may also be used so that the complex-to-real mapping of ĥ_{raw} would not be needed. This can be summarized by the following steps:
obtain raw channel estimates ĥ_{raw} from equation (2),
use [symbol] as the input to the NN, and
interpolate (or extrapolate) the estimates ĥ from the output of the NN to obtain channel estimates over the whole TTI resource grid. Alternatively, interpolation (or extrapolation) may be carried out by the NN by defining its output layer to have as many units as there are resource elements in the TTI.

For example, the NN may have a single (hidden) layer consisting of 2Nₚ neurons (or units) and a linear activation function. Hence, the NN may be described by a linear mapping [symbol] =S [symbol] where S∈ [symbol] ^{2N}^{ₚ}^{×2N}^{ₚ} is a matrix of weights, which may be learned via training the NN.

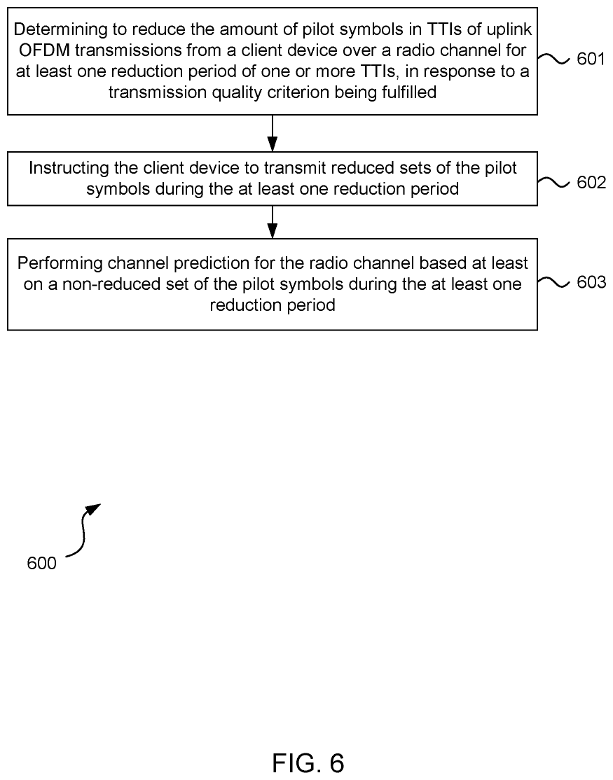

FIG. 6 illustrates an example flow chart of a method 600, in accordance with an example embodiment.

At operation 601, the network node device 200 determines to reduce the amount of pilot symbols in the TTIs of the uplink OFDM transmissions from the client device 120 over the radio channel 130 for the at least one reduction period of one or more TTIs, in response to the transmission quality criterion being fulfilled.

At operation 602, the network node device 200 instructs the client device 120 to transmit reduced sets of the pilot symbols during the at least one reduction period.

At operation 603, the network node device 200 performs the channel prediction for the radio channel 130 based at least on the non-reduced set of the pilot symbols during the at least one reduction period.

The method 600 may be performed by the network node device 200 of FIG. 2. The operations 601-603 can, for example, be performed by the at least one processor 202 and the at least one memory 204. Further features of the method 600 directly result from the functionalities and parameters of the network node device 200, and thus are not repeated here. The method 600 can be performed by computer program(s).

The network node device 200 may comprise means for performing at least one method described herein. In one example, the means may comprise the at least one processor 202, and the at least one memory 204 storing instructions that, when executed by the at least one processor, cause the network node device 200 to perform the method.

The functionality described herein can be performed, at least in part, by one or more computer program product components such as software components. According to an embodiment, the network node device 200 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-ona-chip systems (SOCs), Complex Programmable Logic Devices (CPLDs), and Graphics Processing Units (GPUS).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A network node device, comprising:
at least one processor; and
at least one memory storing instructions that, when executed by the at least one processor, cause the network node device at least to perform:
determining to reduce the amount of pilot symbols in transmission time intervals, TTIs, of uplink orthogonal frequency division multiplexing, OFDM, transmissions from a client device-over a radio channel for at least one reduction period of one or more TTIs, in response to a transmission quality criterion being fulfilled, wherein the transmission quality criterion comprises a block error rate, BLERₙ difference between using a prediction of the radio channel and using a current estimate of the radio channel not exceeding a transmission quality threshold in TTIs not included in the at least one reduction period;
instructing the client device to transmit reduced sets of the pilot symbols during the at least one reduction period; and
performing channel prediction for the radio channel-based at least on anon-reduced set of the pilot symbols during the at least one reduction period.

2. The network node device according to claim 1, wherein the performed channel prediction is further based on at least one reduced set of the pilot symbols.

3. The network node device according to claim 1, wherein the at least one reduction period comprises TTIs between every nth TTI and the channel prediction is performed for TTIs having a reduced set of the pilot symbols.

4. The network node device according to claim 1, wherein the reduced sets of the pilot symbols comprise pilot symbols reduced in frequency domain.

5. The network node device according to claim 1, wherein the reduced sets of the pilot symbols comprise no pilot symbols.

6. (canceled)

7. The network node device according to claim 1, wherein the BLER difference between using the prediction of the radio channel and using the current estimate of the radio channel not exceeding the transmission quality threshold in the TTIs not included in the at least one reduction period comprises:
$${BLER}_{n′} - {BLER}_{n} \leq {A}_{n} ( 1 - \frac{{B}_{n}}{{B}_{{n}^{′}}} )$$
in which Aₙ=−BLERₙ)∈[0,1], BLERₙ represents an average block error rate when transmitting non-reduced pilot symbols every nth TTI,
$${B}_{n} = ( 1 - \frac{{N}_{p}}{n {N}_{FFT} {N}_{OFDM}} ) ,$$
N_{FFT} represents a number of subcarriers, N_{OFDM} represents a number of OFDM symbols in a TTI, and Nₚ represents a number of pilot symbols in every nth TTI, for switching from transmitting pilot symbols at every nth TTI to transmitting pilot symbols at every n'th TTI.

8. The network node device according to claim 7, wherein, when every mth pilot symbol is transmitted between every nth TTI, the BLER difference between using the prediction of the radio channel and using the current estimate of the radio channel not exceeding the transmission quality threshold in the TTIs not included in the at least one reduction period further comprises:
$${BLER}_{{n}^{′} , {m}^{′}} - {BLER}_{n , m} \leq {A}_{n , m} ( 1 - \frac{{B}_{n , m}}{{B}_{{n}^{′} , {m}^{′}}} )$$
as a criterion for switching from transmitting Nₚ pilot symbols at every nth TTI and Nₚ/m pilot symbols between every nth TTI to transmitting Nₚ pilot symbols at every n'th TTI and Nₚ/m′ pilot symbols between every n'th TTI, in which A_{n,m}=(1−BLER_{n,m}) represents an average block success rate using parameters n and m, and
$${B}_{n , m} = ( 1 - \frac{1}{n} ( 1 + \frac{n - 1}{m} ) \frac{{N}_{p}}{{N}_{FFT} {N}_{OFDM}} )$$
represents an average proportion of data carrying resource elements using parameters n and m.

9. The network node device according to claim 1, wherein the performing of the channel prediction comprises, for a n-length sequence of TTIs defined by its first three terms, TTI 1: predicting the radio channel-using non-reduced pilot symbols of the TTI 1, for TTI 2: predicting the radio channel-using reduced pilot symbols of TTI 2 and the non-reduced pilot symbols of TTI 1, and for TTI 3: predicting the radio channel-using reduced pilot symbols of TTI 3 and at least the non-reduced pilot symbols of TTI 1.

10. The network node device according to claim 1, wherein the performing of the channel prediction comprises, for a n-length sequence of TTIs defined by its first three terms, TTI 1: predicting the radio channel-using non-reduced pilot symbols of TTI 1, for TTI 2: using reduced pilot symbols of TTI 2 to update the channel prediction obtained from using the non-reduced pilot symbols of TTI 1, and for TTI 3: using at least reduced pilot symbols of TTI 3 to update the channel prediction obtained from using the non-reduced pilot symbols of TTI 1.

11. The network node device according to claim 1, wherein the performing of the channel prediction comprises applying a set of raw channel estimates from a previous TTI not included in the at least one reduction period as input to a machine learning, ML, model configured to predict the channel.

12. The network node device according to claim 11, wherein the ML model comprises an ML model able to process a varying number of inputs.

13. A method, comprising:
determining, by a network node device, to reduce the amount of pilot symbols in transmission time intervals, TTIs, of uplink orthogonal frequency division multiplexing, OFDM, transmissions from a client device over a radio channel for at least one reduction period of one or more TTIs, in response toa transmission quality criterion being fulfilled, wherein the transmission quality criterion comprises a block error rate, BLERₙ difference between using a prediction of the radio channel and using a current estimate of the radio channel not exceeding a transmission quality threshold in TTIs not included in the at least one reduction period;
instructing, by the network node device, the client device to transmit reduced sets of the pilot symbols during the at least one reduction period; and
performing, by the network node device, channel prediction for the radio channel-based at least on a non-reduced set of the pilot symbols during the at least one reduction period.

14. A computer program comprising instructions for causing a network node device to perform at least the following:
determining to reduce the amount of pilot symbols in transmission time intervals, TTIs, of uplink orthogonal frequency division multiplexing, OFDM, transmissions from a client device over a radio channel for at least one reduction period of one or more TTIs, in response to a transmission quality criterion being fulfilled, wherein the transmission quality criterion comprises a block error rate, BLER, difference between using a prediction of the radio channel and using a current estimate of the radio channel not exceeding a transmission quality threshold in TTIs not included in the at least one reduction period;
instructing the client device to transmit reduced sets of the pilot symbols during the at least one reduction period; and
performing channel prediction for the radio channel based at least on a non-reduced set of the pilot symbols during the at least one reduction period.
